(19) United States
(12) Patent Application Publication
(10) Pub. No.: US 2007/0097440 A1
(43) Pub. Date: May 3, 2007

(54) Partial dot error diffusion halftone calibration

(76) Inventor: Peter Majewicz, Emmett, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/262,274

(22) Filed: Oct. 28, 2005

(51) Int. Cl. H04N 1/405

(52) U.S. Cl. 358/3.06; 358/504

(57) ABSTRACT

Disclosed are methods for calibrating the grain and tone scale of partial dot error diffusion halftoning. The methods include a first pass that calibrates the dot size and a second pass that calibrates tone scale.

### FIELD OF INVENTION

Embodiments of the invention relate generally to improved methods of halftoning images for printing.

### BACKGROUND

Image printing devices, such as electro-photographic (laser) and inkjet printers, print a large number of small dots to create a desired image on a print medium, such as a sheet of paper. The dots are printed in a densely packed pattern that, when viewed by the eye, appears as complete image. This image may be alpha-numeric text, a picture or graphic, or a combination of elements. In a laser printing device, the laser is scanned linearly back and forth across a print drum to create areas or pixels (“dots”) to which toner will adhere when applied, thus creating the image specified by the image data stream.

In order to provide a high quality image, the image printing device must be capable of reproducing a continuum of shades, or levels, between black and white, or between extreme shades of each color. A level may be specified by absorptance. “Absorptance” refers to the fraction of light absorbed by a portion of the printed image. The higher the fraction of absorbed light, as distinguished from reflected light, the darker that portion of the printed image appears. Consequently, within the image printed by the printing device there must be a method of making the printed dots produce gradations or halftones to create a high-quality image.

Halftoning can be accomplished by a number of methods that involve modulating the characteristics of the dots printed. There are two main dot characteristics that can be varied to affect the halftone or grayscale of a portion of an image printed. These two characteristics are the size of the dots and the density of the dots. Varying the size of the dots is sometimes referred to as “AM” modulation, while varying the density is sometimes referred to as “FM” modulation. Both of these characteristics can be modulated simultaneously to control how light or dark, in a gray or color scale, a particular section of the printed image appears (see, for example, U.S. Pat. No. 6,778,299, Lin et al., “Error diffusion with partial dots method and system”).

An inherent limitation of most printing devices that rely on halftoning to produce tone gradations is that the size or diameter of the individual dots may not be absolutely consistent over time or with varying printing conditions. This limitation is commonly referred to as “dot gain”. Dot gain is particularly a problem in those systems that vary the dot size to achieve tone modulation, in that the percent change in dot size may not be consistent over the range of dot sizes. Smaller dot sizes may be affected differently than larger dot sizes, or the smaller dots may fail to “develop” altogether. Such differences may result in visible print quality defects, such as blotchiness.

With printers that are stable and have less dot gain, the advantage of dot size modulation is most significant in highlights, where smaller dots produce less visible highlight textures. With printers that are less stable or have more dot gain, using larger dots in the mid-tones may also result in improved quality.

There is thus a need for methods that enable the advantages of varying dot size in halftoning, while limiting the potential print quality degradation caused by dot gain.

### SUMMARY

Disclosed are exemplary embodiments of the invention which include methods for calibrating the grain and tone scale of partial dot error diffusion halftoning. The methods include a first pass that calibrates the dot size and a second pass that calibrates tone scale.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1 is a flow diagram illustrating the location of the look-up-tables (LUT's) in the rendering process, according to an embodiment of the invention;

FIG. 2 is a flow diagram illustrating the look up table calibration, according to an embodiment of the invention;

FIG. 3 is a plot of measured tone versus programmed dot size for an exemplary printing system;

FIG. 4 is a plot of a calibrated dot LUT for an exemplary printing system;

FIG. 5 is a plot of tone scale for an exemplary printing system, generated by varying the programmed tone level; halftoning; and rendering a printed ramp, including applying the dot size LUT;

FIG. 6 is a plot showing the calibration LUT necessary to linearize the exemplary printing system with the tone scale of FIG. 5;

FIG. 7 is a plot showing a calibrated tone scale for an exemplary printing system, which is the final calibrated state of the printer, with the tone calibration LUT applied to a contone image and with the dot size LUT applied prior to rendering; and

FIG. 8 is a plot illustrating how methods of the invention aid in reducing contouring in printed images.

### DESCRIPTION OF EMBODIMENTS OF THE INVENTION

Embodiments of the invention are described with respect to an electro-photographic (EP) printing system; however, the invention is not limited to the exemplary system, nor to the field of laser printing, but may be utilized as well in other systems, such as inkjet printers.

In the following specification, for purposes of explanation, specific details are set forth in order to provide an understanding of the present invention. It will be apparent to one skilled in the art, however, that the present invention may be practiced without these specific details. Reference in the specification to “one embodiment” or “an exemplary embodiment” means that a particular feature, structure, or characteristic described in connection with the embodiment is included in at least one embodiment. The appearance of the phrase “in one embodiment” in various places in the specification do not necessarily refer to the same embodiment.

Standard error diffusion halftoning techniques are susceptible to grain defects. Partial dot error diffusion (e.g., U.S. Pat. No. 6,778,299) reduces grain by using partial dots in appropriate places along the tone scale. Small dots are used for highlights and large dots are used for midtones and shadows.

A problem with partial dot error diffusion, and other dispersed-partial-dot halftone algorithms, is that they may become unstable when used in conjunction with electro-photography (EP). As EP parameters drift, such as with time, environmental conditions, or wear, the size of the dots may vary and smaller dots may disappear, or fail to “develop”. The variation disrupts the grain structure and causes dot gain variations, which in turn cause displeasing microstructure in printed images and inaccurate colors.

An existing solution calibrates the tone scale using a lookup table (LUT) operating on the color channel bits. The LUT typically directly remaps levels, with each input tone value replaced with a corresponding output tone value. The LUT may exist prior to the halftoning or be embedded within the halftoning process. If embedded, other LUT's are typically adjusted in conjunction with the tone LUT. Remapping using the channel LUT suffers from contouring if applied in high dot gain situations and if applied in an eight bit/pixel (or less) channel. Most channels used in EP printing systems are eight bit. Remapping does not address grain.

The disclosed exemplary methods counteract dot size drift with an embedded calibration process. The process consists of a photo sensor, such as a densitometer, measuring tone scales and adjusting a tone look-up-table (TL) and a dot size look-up-table (DL). The exemplary processes employ two measurement and adjustment passes.

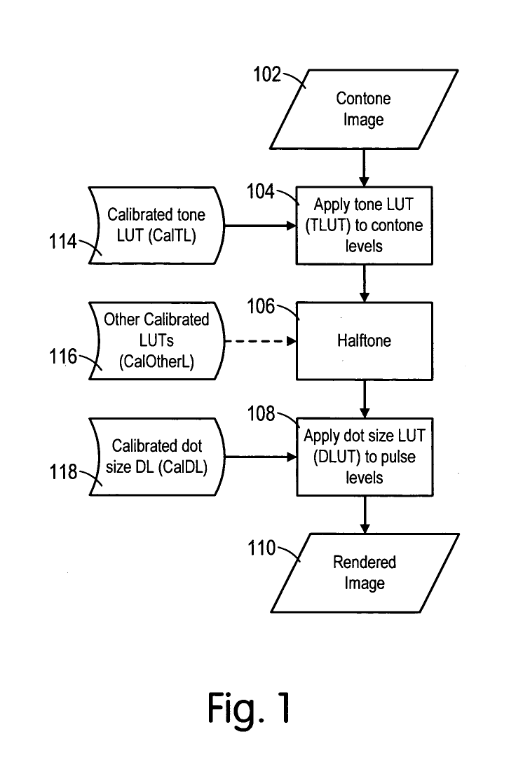

FIG. 1 shows the location of the look-up-tables (LUT's) in an exemplary rendering process. The look-up-tables may be actual tables of values stored in a memory, or may alternatively be reduced to coefficients of equations which substantially represent the table data. The rendering process begins with a “contone” or continuous tone image 102, in which typically each color channel of the image has a discrete value, such as, for example, from zero to 255. The tone LUT 114, which contains previously obtained tone calibration data, is applied 104 directly to the contone image. That is, the continuous tone values of the image are adjusted based upon the measured printer tone characteristics contained in the tone LUT 114. The image is then halftoned 106 with a multi-level algorithm such as partial dot error diffusion (PDED). Depending on the particular halftoning algorithm, additional calibration LUT's 116 may be employed in the halftoning process.

The calibrated dot size LUT 118, which contains previously obtained dot size calibration data, is then applied to the dots of the halftoned image 108. In an electro-photographic process, the dot size may typically be controlled by varying laser pulse levels or pulsewidths. The resulting dot sizes are then utilized in rendering 110 the image. If the process is color then there are separate LUT's for each color channel. A standard CMYK (cyan, magenta, yellow, black) process thus has four tone and four dot size LUT's.

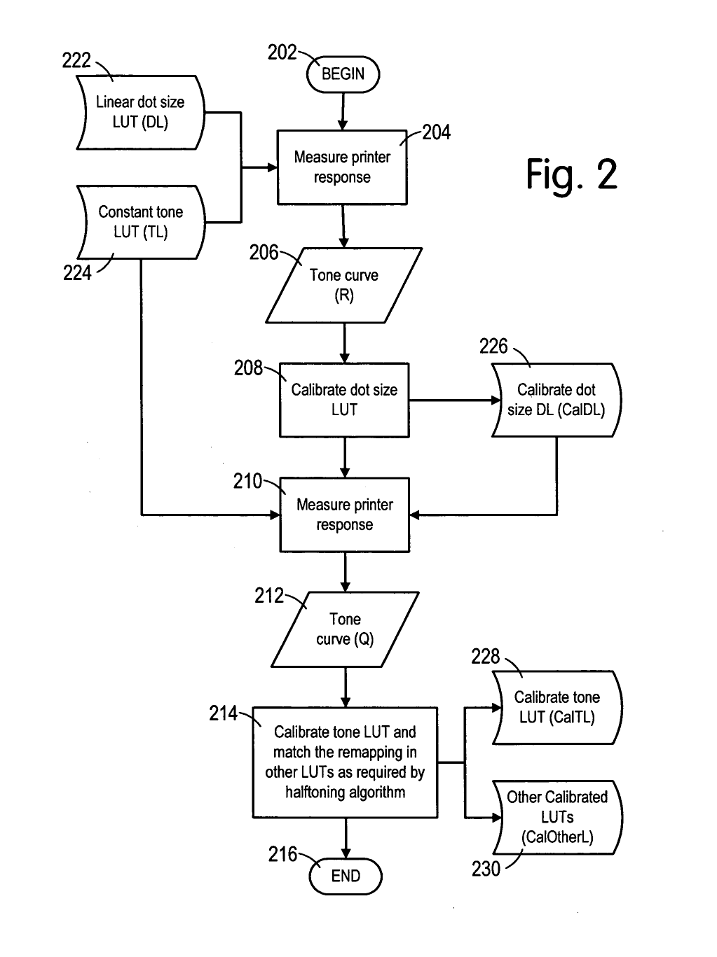

FIG. 2 shows an exemplary LUT calibration sequence. A discrete ramp is printed through the rendering process using a constant tone LUT 224 and a linear dot size LUT 222, and the printer response measured 204. That is, a pattern is printed in which the density of the dots is held constant, while the uncalibrated dot size is varied linearly, as described below. The tone (absorptance) of each patch of the ramp is measured, such as with an integral built-in photo sensor in the printing system.

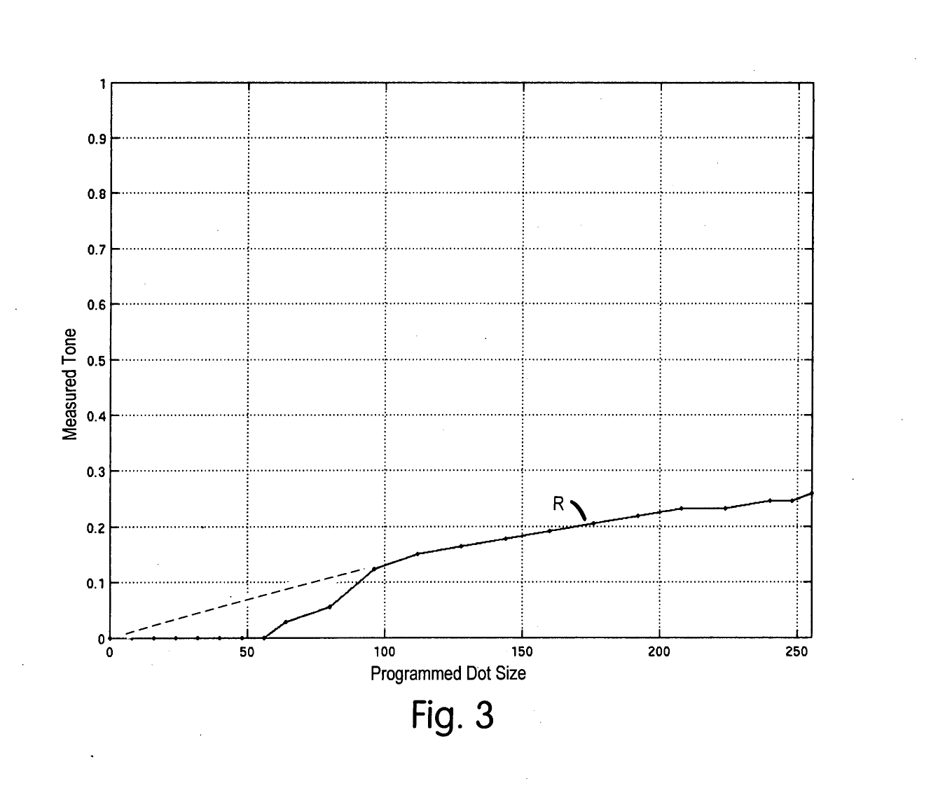

The relation “R” of tone against dot size is an indication of the physical dot size. FIG. 3 shows a plot of R for an exemplary printing system. The horizontal axis is exposure pulse width units (in the example shown, a binary value from 0 to 255). The printed ramp from which the data of FIG. 3 was measured was created by holding the dot density constant, at a value which would yield about 25% total coverage of the print media at the largest programmed dot size, while the programmed dot size was varied (from 0 to 255). The vertical axis is the resulting actual measured tone. In a hypothetical “ideal” EP printer, R might be expected to show a linear response from the graph origin, as indicated by the dashed line. In a real EP printer, the smaller dot sizes may fail to “develop”. In the particular case shown in FIG. 3, dots do not develop in the exposure pulse width unit range of [0,56]. This range is thus unusable for partial dotting. Dots do develop above 56, and the range of [57,255] is usable for partial dotting.

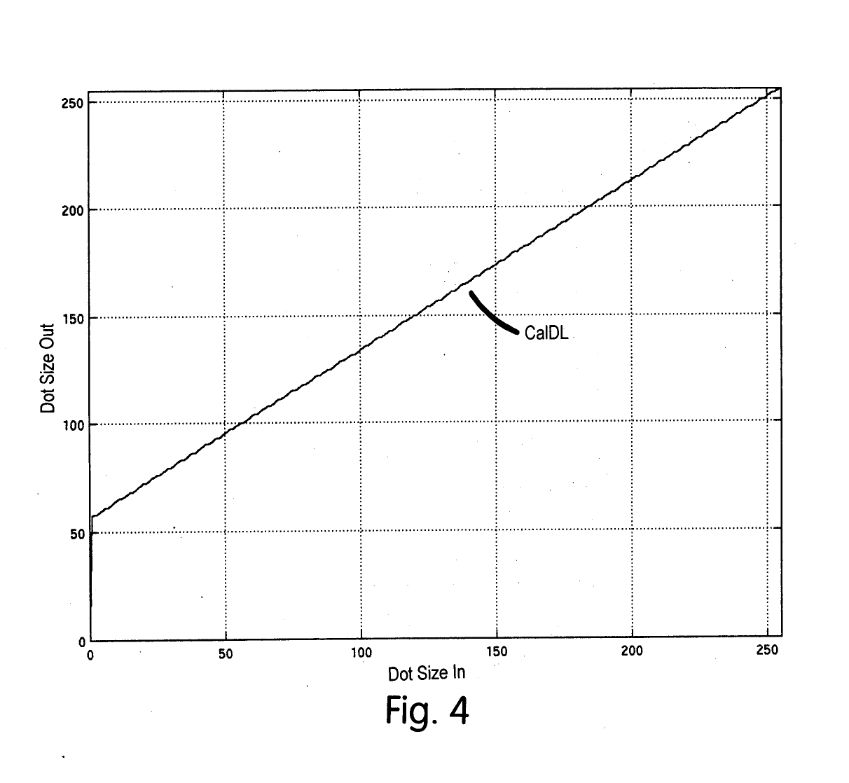

In an exemplary embodiment, the dot size LUT is calibrated 208 (ref. FIG. 2) to be offset linear. That is, rather than completely calibrating the dot size based on the measure R to remove all contributions to dot size deviation, the process may be somewhat simplified by utilizing a linear calibration for dot size. An offset linear dot size LUT generated from R is shown in FIG. 4.

In an exemplary method, the dot size LUT may be generated as follows:

Let d_{intercept} be the place where R crosses the horizontal axis (ref. FIG. 3), let j be an indexer variable, and n the number of levels in the color channel (in the exemplary method, 256). The intermediate calibrated dot size LUT CalDL is

$$\begin{matrix}j ε [ 0 , 1 , 2 , … n - 1 ] & eq . 1 \\ {CalDL}_{j} = \{ \begin{matrix}j = 0 , {DL}_{j} = 0 \\ 0 < j \leq n - 1 , {CalDL}_{j} = ( n - 1 - {d}_{intercept} ) * j / ( n - 1 ) + {d}_{intercept}\end{matrix} & eq . 2\end{matrix}$$

FIG. 4 shows an exemplary CalDL corresponding to R in FIG. 3. The horizontal axis represents the pulse width units or “dot size in”; the vertical axis represents the pulse width units or “dot size out”.

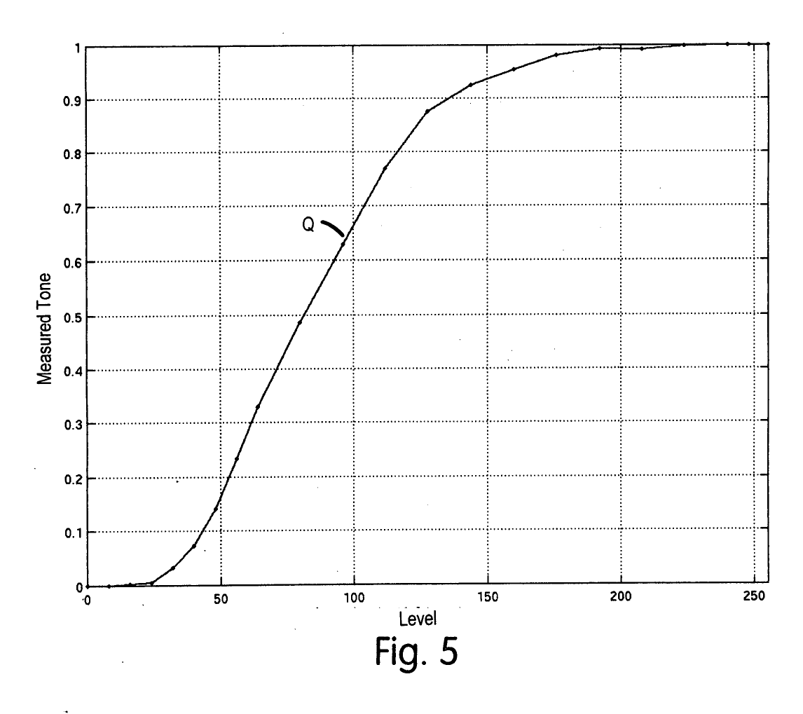

Next, CalDL 226 and the linear tone LUT 224 are used to print another ramp that is measured 210 to provide a tone scale Q 212 (ref. FIG. 2). FIG. 5 shows a resulting exemplary tone scale Q. The tone scale Q is generated by varying the programmed tone level (the horizontal axis in FIG. 5 shows an exemplary system in which the programmed tone may be varied from 0 to 255), halftoning, and rendering the ramp, including applying the dot size LUT prior to rendering. The resulting tone ramp is then measured, typically using a built-in photo sensor in the printing system.

For a linear target tone scale, the calibrated tone LUT (CalTL) is:
CalTLⱼ=k such that Qₖ*(n−1)=j eq. 3

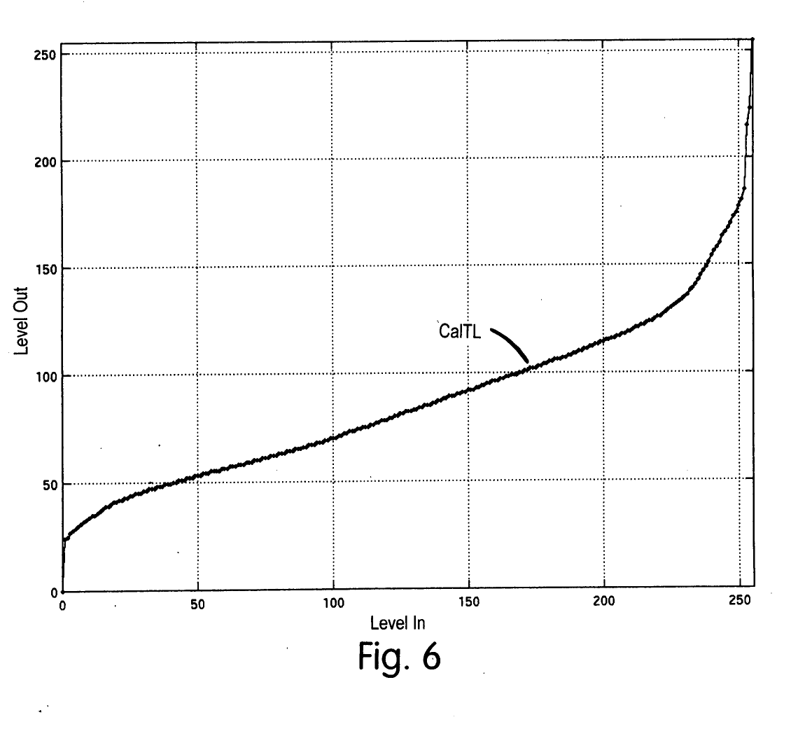

FIG. 6 shows the CalTL that makes the tone scale in FIG. 5 linear. That is, when the LUT data of CalTL is applied to a contone image and then halftoned and rendered (including applying the dot LUT) on an exemplary printer having the measured tone characteristics of FIG. 4, a linear tone response should be achieved.

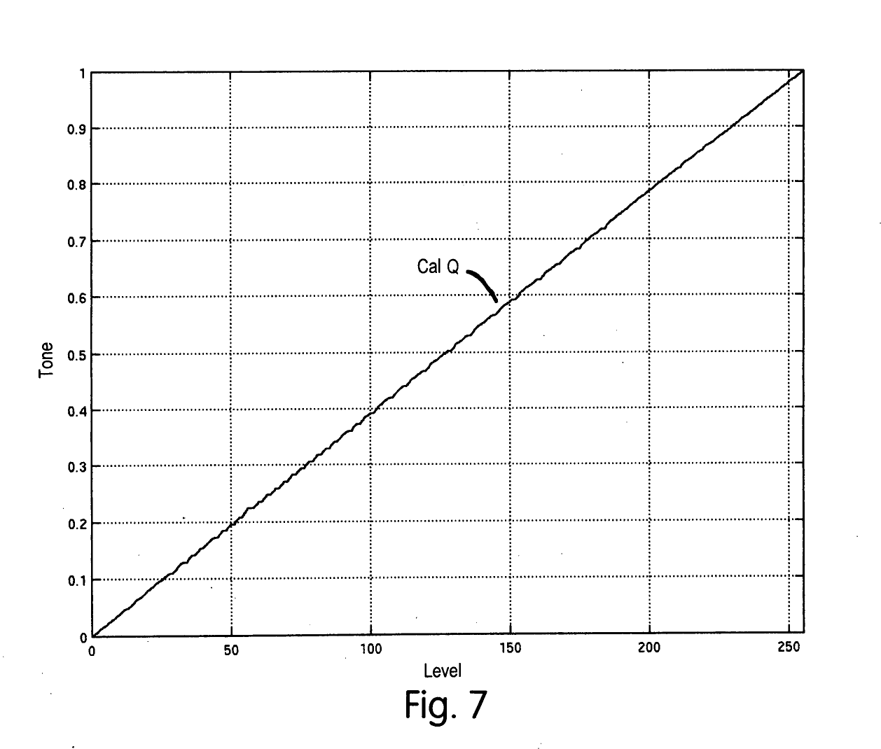

FIG. 7 shows the calibrated tone scale CalQ. CalQ is the final calibrated state of the printer, with the LUT data of CalTL applied to a contone image, and with the dot size LUT applied prior to rendering.
CalQⱼ=Q(CalTLⱼ/(n−1)) eq. 4

In some implementations of partial dot error diffusion (PDED), the dot size may need to be adjusted 214 in step with the tone LUT to preserve growth behavior (see U.S. Pat. No. 6,778,299). Designating a LUT modified in such a manner with a prime ′:
kε[0, 1, 2, . . . n−1] eq. 5
CalDL′ⱼ=CalDLₖ such that Qₖ*(n−1)=j eq. 6

Other LUT's may need to be adjusted in-step. These others are represented here as 1 additional LUT 230.
CalOtherL′ⱼ=CalOtherLₖ such that Qₖ*(n−1)=j eq. 7

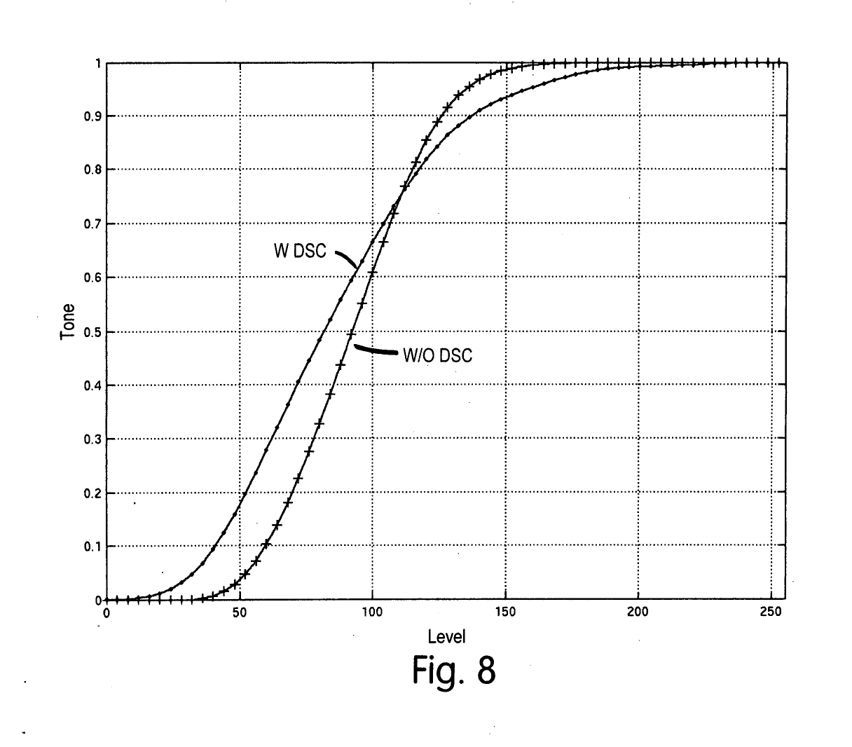

An advantage of the exemplary methods is that print quality defects, such as blotches resulting from non-developing small dots, may be reduced. A further advantage of the exemplary methods is that, by applying the tone LUT to the contone image and then applying the dot size LUT prior to rendering, improved tonal resolution is possible, and defects due to contouring may be reduced. For example, FIG. 8 shows tonal calibration for an exemplary printing system both with separate dot size calibration (DSC) and without separate dot size calibration (W/O DSC). It may be observed that the slope of portions of the curve without separate dot size calibration (i.e., with the tone LUT typically directly remapping levels) are substantially steeper than the curve including dot size calibration, indicative of reduced resolution. In an image having subtle tone changes (such as a photograph including sky), more discrete levels are typically available within a given range of tones when dot size calibration is applied as a separate step prior to rendering.

The above is a detailed description of particular embodiments of the invention. It is recognized that departures from the disclosed embodiments may be within the scope of this invention and that obvious modifications will occur to a person skilled in the art. It is the intent of the applicant that the invention include alternative implementations known in the art that perform the same functions as those disclosed. This specification should not be construed to unduly narrow the full scope of protection to which the invention is entitled.

The corresponding structures, materials, acts, and equivalents of all means or step plus function elements in the claims below are intended to include any structure, material, or acts for performing the functions in combination with other claimed elements as specifically claimed.

What is claimed is:

1. A method of calibrating a printing system, the printing system: producing multi dot sizes in halftoned images, the method comprising:
performing a dot size calibration; and
utilizing the dot size calibration, performing a tone scale calibration.

2. The method of calibrating a printing system of claim 1, wherein the printing system comprises an electro-photographic printer.

3. The method of calibrating a printing system of claim 1, wherein the printing system comprises an inkjet printer.

4. The method of calibrating a printing system of claim 1, wherein performing the dot size calibration comprises:
printing a pattern of uncalibrated dots, and
measuring the tone of the printed pattern.

5. The method of calibrating a printing system of claim 4, wherein printing a pattern of uncalibrated dots comprises printing a ramp with varying dot size while holding the density of dots constant.

6. The method of calibrating a printing system of claim 5, wherein printing the ramp further comprises printing a ramp with linearly varying dot size.

7. The method of calibrating a printing system of claim 4, wherein measuring the tone of the printed pattern comprises measuring the tone using a densitometer.

8. The method of calibrating a printing system of claim 7, wherein the densitometer is integral with the printing system.

9. The method of calibrating a printing system of claim 4, further comprising creating a dot size look-up-table (LUT) and storing the LUT.

10. The method of calibrating a printing system of claim 1, wherein performing a tone scale calibration comprises:
generating a halftoned test image utilizing multiple dot sizes;
adjusting the dot sizes of the halftoned test image according to a previously performed dot size calibration;
printing the adjusted halftoned test image; and
measuring the tone of the printed pattern.

11. The method of calibrating a printing system of claim 10, wherein generating a halftoned test image utilizing multiple dot sizes comprises generating a ramp with varying tone.

12. The method of calibrating a printing system of claim 10, wherein measuring the tone of the printed pattern comprises measuring the tone using a densitometer.

13. The method of calibrating a printing system of claim 12, wherein the densitometer is integral with the printing system.

14. The method of calibrating a printing system of claim 10, further comprising creating a tone look-up-table (LUT) and storing the LUT.

15. The method of calibrating a printing system of claim 1, wherein performing dot size calibration substantially precludes printing with non-developing dot sizes.

16. A method of calibrating a printing system, the printing system producing multi dot sizes in halftoned images, the method comprising:
printing a dot test pattern of uncalibrated dots,
measuring the tone of the printed dot test pattern;
based on the measured tone of the printed dot pattern, creating a dot calibration look-up-table (LUT);
printing an uncalibrated tone test pattern, the printing utilizing the dot calibration LUT;
measuring the tone of the printed tone test pattern; and
based on the measured tone of the tone test pattern, creating a tone calibration LUT.

17. The method of calibrating a printing system of claim 16, wherein the printing system comprises an electro-photographic printer.

18. The method of calibrating a printing system of claim 16, wherein the printing system comprises an inkjet printer.

19. The method of calibrating a printing system of claim 16, wherein printing a pattern of uncalibrated dots comprises printing a ramp with linearly varying dot size while holding the density of dots constant.

20. The method of calibrating a printing system of claim 16, wherein performing a tone scale calibration comprises:
generating a halftoned test image utilizing multiple dot sizes;
adjusting the dot sizes of the halftoned test image according to a previously performed dot size calibration;
printing the adjusted halftoned test image; and
measuring the tone of the printed pattern.

21. The method of calibrating a printing system of claim 20, wherein generating a halftoned test image utilizing multiple dot sizes comprises generating a ramp with varying tone.

22. The method of calibrating a printing system of claim 16, wherein the method is repeated for each of multiple color channels.

23. A method of printing an image, the image received as a contone image, the method comprising:
adjusting the tone values of the contone image based upon previously obtained tone calibration data;
halftoning the image utilizing a multi-level algorithm to produce halftone data having multiple dot sizes;
adjusting the dot sizes based upon previously obtained dot size calibration data; and
printing the image.

24. The method of printing an image of claim 23, wherein the previously obtained tone calibration data was obtained while utilizing the previously obtained dot size calibration data.
